(19) United States
(12) Patent Application Publication
(10) Pub. No.: US 2009/0225486 A1
(43) Pub. Date: Sep. 10, 2009

(54) Electrical Connector And Method Of Manufacturing Same

(75) Inventor: John Wadsworth, Burbank, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/044,897

(22) Filed: Mar. 7, 2008

(51) Int. Cl. H02H 3/22; H01R 39/02; H01R 24/08; H01R 24/12; H01R 13/648

(52) U.S. Cl. 361/118; 439/13; 439/106; 439/660

(57) ABSTRACT

In one embodiment, an electrical connector comprises a housing, at least two electrical outlets accessible through the housing, a rotation coupler at least partially enclosed by the housing and coupled to the at least two electrical outlets, and a prong adapter coupled to the rotation coupler. The rotation coupler comprises a line contact, a neutral contact, and a ground contact. The prong adapter comprises a prong set with at least two of a line prong configured to couple with the line contact, a neutral prong configured to couple with the neutral contact, and a ground prong configured to couple with the ground contact. The rotation coupler is configured to allow a rotational movement of the housing relative to the prong adapter.

### TECHNICAL FIELD

This invention relates generally to electrical connectors, and relates more particularly to rotatable electrical connectors.

### BACKGROUND

Electrical connectors, such as surge protectors, can be used to couple electrical products to power sources. Many electrical connectors, however, are undesirable in some circumstances, including travel applications, when it comes to providing flexibility and functionality for coupling electrical products to power sources. Also, most electrical connectors designed for travel applications are ungrounded, and thus are incompatible for electrical products with polarized electrical prongs, or plugs incorporating a ground prong. Other electrical connectors are too unwieldy for travel applications because they comprise bulky power cords or are fixed in one orientation defined by the alignment of their power prongs relative to prong sockets on the power source. This configuration in turn forces electrical products and/or their power plugs to couple to the electrical connector at one specific orientation, which may not be suitable for the particular electric product, or the particular location where the power source is situated. In addition, most electrical connectors are limited to couple with only one type of power source outlet, and thus cannot couple to power sources in countries with different electrical standards and/or different power source outlets.

Accordingly, a need exists for a compact electrical connector that addresses these problems by providing more flexibility for coupling to different power sources, and more alignment options for coupling electrical products.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates a top, side, rear isometric view of an electrical connector, showing a prong adapter coupled to the electrical connector's housing via a rotation coupler, according to a first embodiment.

FIG. 2 illustrates a bottom, side, rear isometric view of the electrical connector from FIG. 1

FIG. 3 illustrates a bottom, side, front isometric view the electrical connector from FIG. 1

FIG. 4 illustrates a front view of a portion of the electrical connector from FIG. 1, showing the prong adapter decoupled form the rotation coupler.

FIG. 5 illustrates a front view of the prong adapter from FIGS. 1-3.

FIG. 6 illustrates a rear view of the prong adapter from FIGS. 1-3.

FIG. 7 illustrates a cross sectional view of the electrical connector of FIG. 1, showing a locking mechanism and internal connections of different elements.

FIG. 8 illustrates a front view of the electrical connector of FIG. 1 at a first predetermined orientation.

FIG. 9 illustrates a front view of the electrical connector of FIG. 1 at a second predetermined orientation.

FIG. 10 illustrates a front view of the electrical connector of FIG. 1 at a third predetermined orientation.

FIG. 11 illustrates a front view of the electrical connector of FIG. 1 at a fourth predetermined orientation.

FIG. 12 illustrates a front view of the electrical connector of FIG. 1 at a fifth predetermined orientation.

FIG. 13 illustrates a front view of the electrical connector of FIG. 1 at a sixth predetermined orientation.

FIG. 14 illustrates a front view of the electrical connector of FIG. 1 at a seventh predetermined orientation.

FIG. 15 illustrates a front view of the electrical connector of FIG. 1 at an eighth predetermined orientation.

FIG. 16 illustrates a cross sectional, isometric view of a portion of an electrical connector, which is a similar embodiment of the electrical connector of FIGS. 1-15, without a prong adapter.

FIG. 17 illustrates an isometric front view of a prong adapter of the electrical connector of FIG. 16.

FIG. 18 illustrates an isometric rear view of the prong adapter of FIG. 17.

FIG. 19 illustrates an isometric view of a portion of an electrical connector, which is a similar embodiment of the electrical connector of FIGS. 1-15 and the electrical connector of FIGS. 16-18, without a prong adapter,

FIG. 20 illustrates a rear view of a prong adapter of the electrical connector of FIG. 19.

FIG. 21 illustrates a translucent rear view of the prong adapter of FIG. 20.

FIG. 22 illustrates a translucent rear view of a prong adapter interchangeable with the prong adapter of FIG. 20-21.

FIG. 23 illustrates a cross sectional, isometric view of a portion of an electrical connector, which is a similar embodiment of the electrical connector of FIG. 16.

FIG. 24 illustrates a flowchart of a method of manufacturing an electrical connector.

For simplicity and charity of illustration, the drawing figures illustrate the general manner of construction, and descriptions and details of well-known features and techniques may he omitted to avoid unnecessarily obscuring the invention. Additionally, elements in the drawing figures are not necessarily drawn to scale. For example, the dimensions of some of the elements in the figures may be exaggerated relative to other elements to help improve understanding of examples of embodiments. The same reference numerals in different figures denote the same elements.

The terms “first” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, physically, mechanical, or other manner. The term “ring,” as used herein, includes items with a general annular, elliptical, polygonal, circular, and/or oval shape.

### DETAILED DESCRIPTION OF EXEMPLARY EMBODIMENTS

In one embodiment, an electrical connector comprises a housing, at least two electrical outlets accessible through the housing, a rotation coupler at least partially enclosed by the housing and coupled to the at least two electrical outlets, and a prong adapter coupled to the rotation coupler. The rotation coupler comprises a line contact, a neutral contact, and a ground contact. The prong adapter comprises a prong set with at least two of a line prong configured to couple with the line contact, a neutral prong configured to couple with the neutral contact, and a ground prong configured to couple with the ground contact. The rotation coupler is configured to allow a rotational movement of the housing relative to the prong adapter.

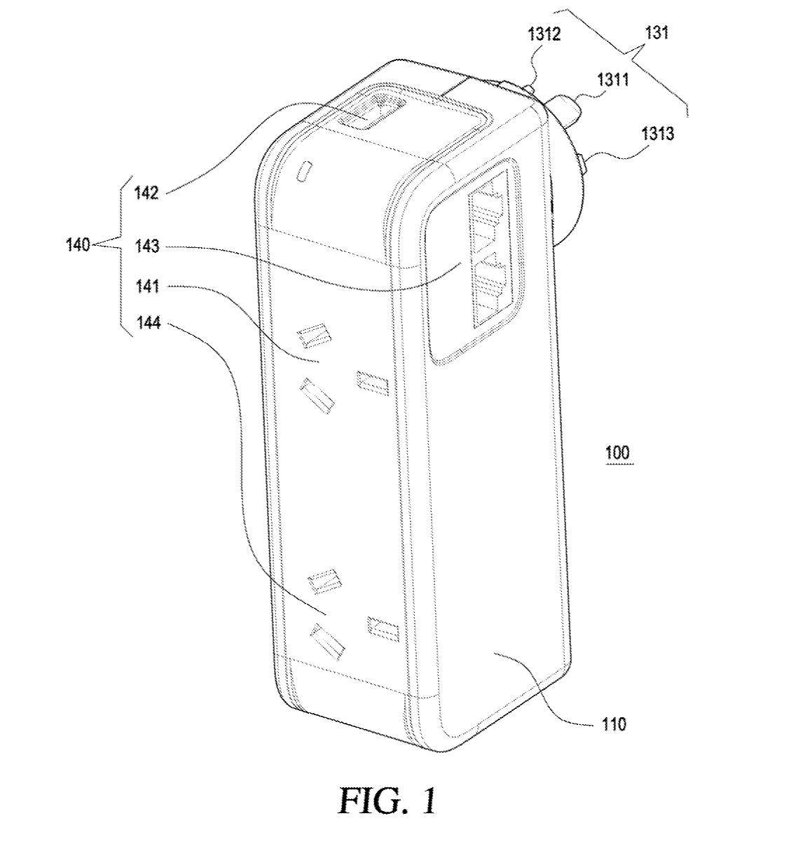

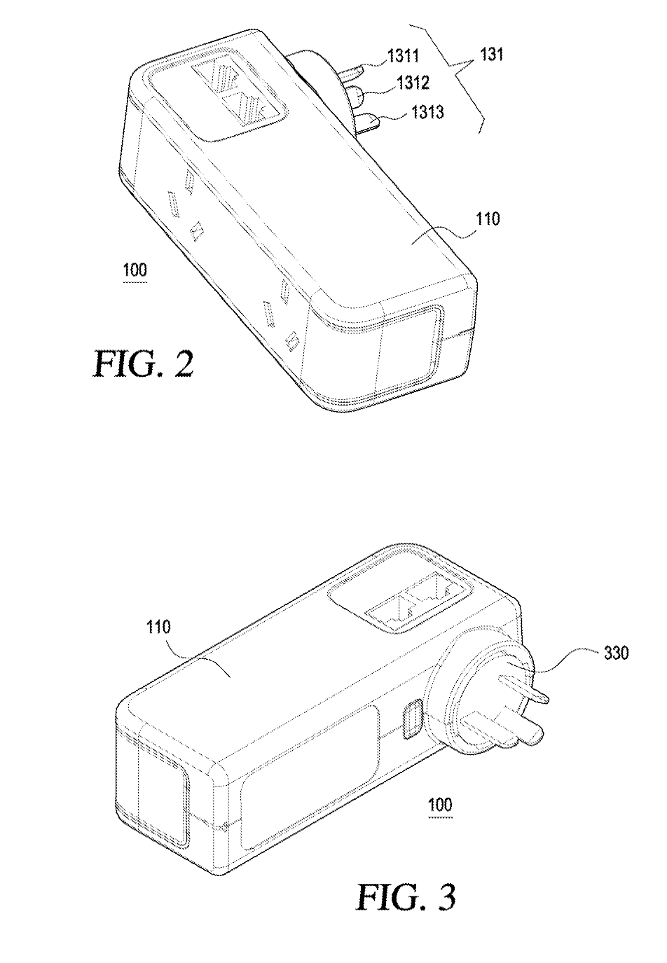

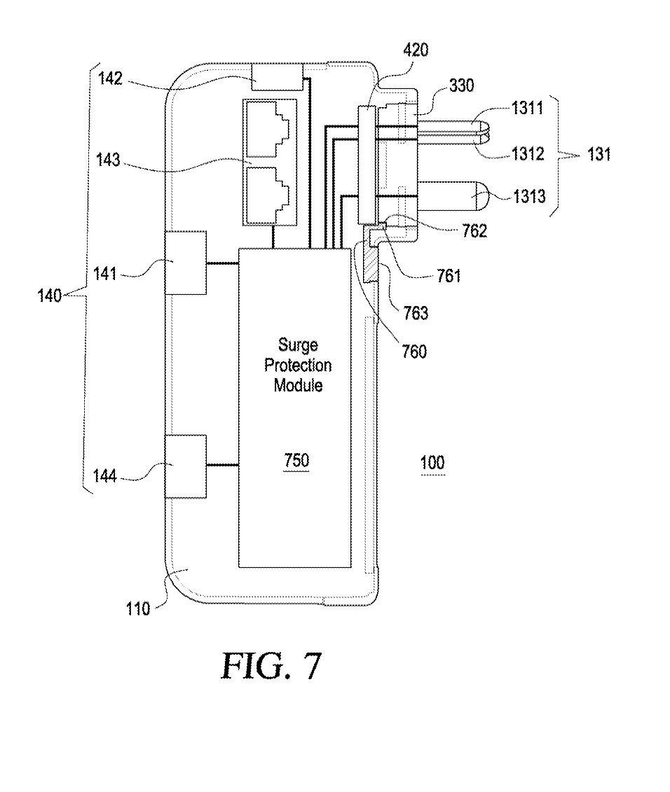

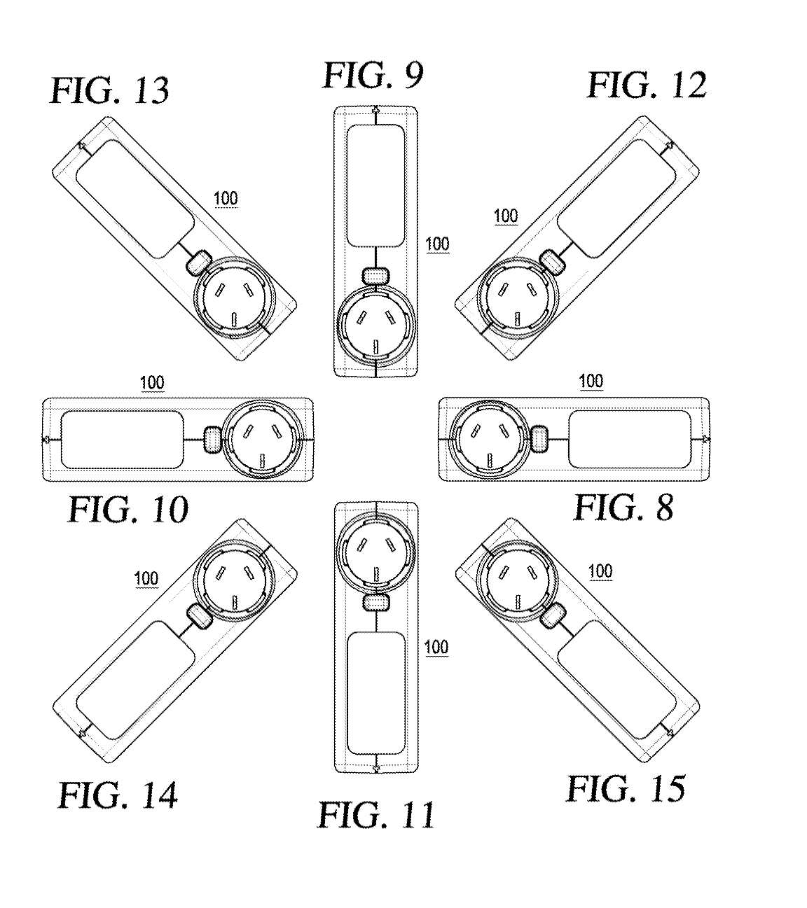

Turning to the drawings, FIG. 1 illustrates a top, side, rear isometric view of electrical connector 100, according to a first embodiment. FIG. 2 illustrates a bottom, side, rear isometric view of electrical connector 100. FIG. 3 illustrates a bottom, side, front isometric view of electrical connector 100. FIG, 4 illustrates a front view of a portion of electrical connector 100, with prong adapter 330 decoupled form rotation coupler 120. FIG. 5 illustrates a front view of prong adapter 330. FIG. 6 illustrates a rear view of prong adapter 330. FIG. 7 illustrates a cross sectional view of electrical connector 100, showing internal connections of different elements. FIG. 8 illustrates a front view of electrical connector 100 at a first predetermined orientation of housing 110 relative to prong adapter 330. FIG. 9 illustrates a front view of electrical connector 100 at a second predetermined orientation. FIG. 10 illustrates a front view of electrical connector 100 at a third predetermined orientation. FIG. 11 illustrates a front view of electrical connector 100 at a fourth predetermined orientation. FIG. 12 illustrates a front view of electrical connector 100 at a fifth predetermined orientation. FIG. 13 illustrates a front view of electrical connector 100 at a sixth predetermined orientation. FIG. 14 illustrates a front view of electrical connector 100 at a seventh predetermined orientation. FIG. 15 illustrates a front view of electrical connector 100 at an eighth predetermined orientation.

Electrical connector 100 is merely exemplary and is not limited to the embodiments presented herein. Electrical connector 100 can be employed in many different embodiments or examples not specifically depicted or described herein.

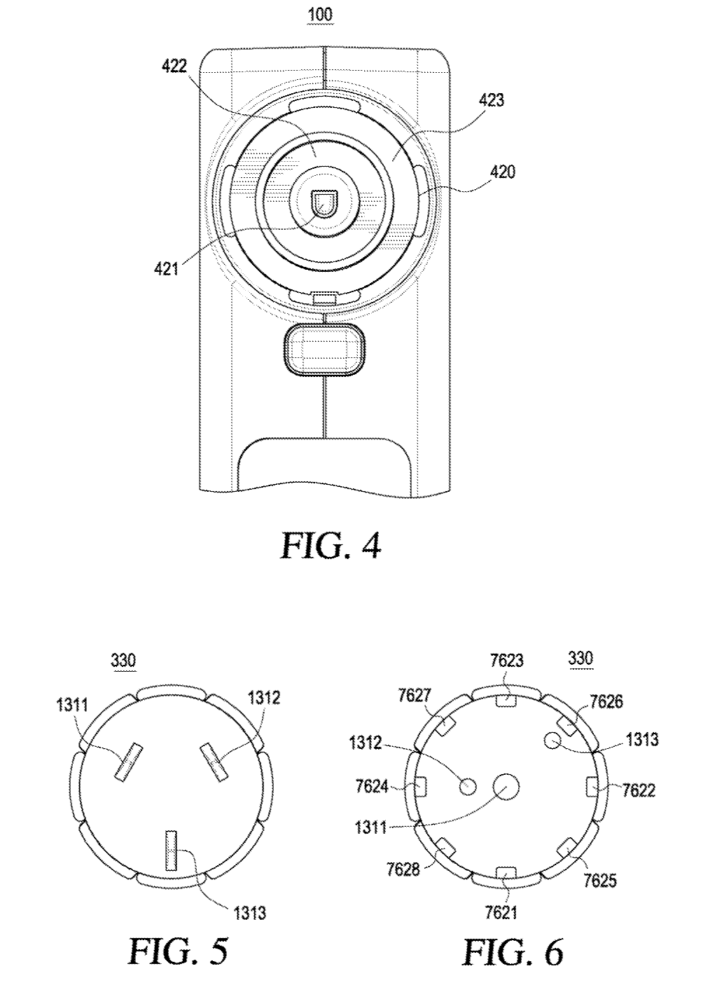

In the example shown in FIGS. 1-15, electrical connector 100 comprises a housing 110, with rotation coupler 420 (FIG. 4) at least partially enclosed by housing 110, and with electrical outlets 140 accessible through the exterior of housing 110. Electrical connector 100 further comprises prong adapter 330 (FIG. 3), with prong set 131, coupled to housing 110 via rotation coupler 420. Electrical connector 100 can comprise, for example, a power strip or power bar.

In one embodiment, housing 110 can have dimensions of approximately 130×50×41 millimeters (mm). In the same or a different embodiment, housing 110 can comprise a neck with a diameter of approximately 38.5 mm protruding from housing 110 a distance of approximately 9 mm. In a different embodiment, any of the listed dimensions of housing 110 can be increased or decreased by up to 30 mm.

In the present embodiment, electrical outlets 140 comprise AC outlet 141, USB outlet 142, Ethernet outlet 143, and AC outlet 144. In a different embodiment, electrical connector 100 can comprise other combinations of electrical outlets 140, including different types of electrical outlets 140 not specifically shown in the example of FIGS. 1-15 such as telephone jacks.

In the example of FIGS. 1-15, one or more of electrical outlets 140 are electrically coupled to prong set 131 via the interior of housing 110 (FIG. 7). Electrical connector 100 can thus be used to provide an electrical connection from an electrical source (not shown) coupled to prong set 131 to one or more electrical devices (not shown) coupled to one or more of electrical outlets 140. In one example, the electrical source can be an AC wall outlet to which prong set 131 of prong adapter 330 couples. In a different example, the electrical source can be an extension cord or another power bar or strip comprising outlets to which prong set 131 can also couple.

In the same or a different example, electrical connector 100 can comprise surge protection module 750 (FIG, 7) contained within housing 110 and coupled to electrical outlets 140 to protect any electrical devices coupled to electrical outlets 140 from voltage spikes or other power conditioning inconsistencies of the electrical source by, for example, blocking or shorting to ground voltages above a safe threshold.

Surge protection module 750 can be electrically coupled between rotation coupler 420 and electrical outlets 140 (FIG. 7). In such an example, when prong adapter 330 couples to rotation coupler 120, the surge protection module lies along the electrical path between prong set 131 and electrical outlets 140 to restrict power conditioning inconsistencies from reaching or affecting the electrical devices coupled to electrical outlets 140. In a different example, surge protection module 750 may not be provided, and the electrical path between electrical outlets 140 and prong set 131 would be more direct while foregoing protection against power conditioning inconsistencies.

As illustrated in FIGS. 4-6, the rotation coupler 420 of electrical connector 100 comprises contact 421, contact 422, and contact 423, while prong adapter 330 comprises at least two of prong 1311, prong 1312, and prong 1313. Parts of prongs 1311-1313 that protrude through the side of prong adapter 330 configured to contact rotation coupler 420 can be referred to as couplers. Electrical connector 100 is configured such that, when prong adapter 330 is coupled to rotation coupler 420, contact 421 couples to prong 1311, and contact 422 couples to prong 1312. In addition, for cases where prong adapter 330 comprises prong 1313, contact 423 couples to prong 1313 when prong adapter 330 is coupled to rotation coupler 420. In this embodiment, prong 1313 can be a ground prong.

Different prongs may be assigned different characteristics in different embodiments. However, as will be seen from the following examples, the coupling relationship between one type of prong and the corresponding type of contact remains constant.

In one example, prong 1311 and contact 421 comprise a line prong and a line contact, respectively, and prong 1312 and contact 422 comprise a neutral prong and a neutral contact, respectively, while prong 1313 and contact 423 comprise a ground prong and a ground contact, respectively.

In a different example, prong 1311 and contact 421 comprise a line prong and a line contact, respectively, and prong 1312 and contact 422 comprise a ground prong and a ground contact, respectively, while prong 1313 and contact 423 comprise a neutral prong and a neutral contact, respectively.

In an alternate example, prong 1311 and contact 421 comprise a neutral prong and a neutral contact, respectively, and prong 1312 and contact 422 comprise a line prong and a line contact, respectively, while prong 1313 and contact 423 comprise a ground prong and a ground contact, respectively.

In another different example, prong 1311 and contact 421 comprise a neutral prong and a neutral contact, respectively, and prong 1312 and contact 422 comprise a ground prong and a line contact, respectively, while prong 1313 and contact 423 comprise a line prong and a line contact, respectively.

In another alternate example, prong 1311 and contact 421 comprise a ground prong and a ground contact, respectively, and prong 1312 and contact 422 comprise a line prong and a line contact, respectively, while prong 1313 and contact 423 comprise a neutral prong and a neutral contact, respectively.

In yet another different example, prong 1311 and contact 421 comprise a ground prong and a ground contact, respectively, and prong 1312 and contact 422 comprise a neutral prong and a neutral contact, respectively, while prong 1313 and contact 423 comprise a line prong and a line contact, respectively.

In yet another alternate example, other combinations can be possible, including examples where prong adapter 330 comprises only two of prong 1311, prong 1312, and prong 1313.

In many embodiments, however, the line prong is configured to couple to the line contact, the neutral prong is configured to couple to the neutral contact, and the ground prong is configured to couple to the ground contact, when rotation coupler 420 is coupled to prong adapter 330. In one embodiment, this configuration can be achieved by placing the line contact a first distance away from a center of rotation coupler 420, the neutral contact a second distance away from the center of rotation coupler 420, and the ground contact a third distance away from the center of rotation coupler 420 (FIG. 4), while locating a line coupler of the line prong a first distance away from a center of prong adapter 330, a neutral coupler of the neutral prong a second distance away from the center of prong adapter 330, and a ground coupler of the ground prong a third distance away from the center of prong adapter 330 (FIG. 6), wherein the first, second, and third distance from the center of rotation coupler 420 are substantially equal, respectively, to the first second and third distance from the center of prong adapter 330.

As illustrated in FIGS. 8-15, rotation coupler 420 is configured to allow a rotational movement of housing 110 relative to prong adapter 330. In the present embodiment of FIGS. 1-15, the rotational movement of housing 110 comprises 360 degrees relative to prong adapter 330. In a different example, the rotational movement of housing 110 could be limited to a subset of 360 degrees relative to prong adapter 330.

In the present embodiment, as illustrated in FIGS. 6 and 7, rotation coupler 420 comprises a portion of a locking mechanism 760. The portion of locking mechanism 760 comprises a lock 761 coupled to rotation coupler 420 (FIG. 7). In addition, prong adapter 330 comprises a second portion of locking mechanism 760 with two or more lock receivers 762 complementary to lock 761 (FIG. 6-7). In the present example, the two or more lock receivers 762 comprise eight lock receivers 7621-7628 spaced around prong adapter 330 in increments comprising multiples of 45 degrees of rotation. In a different example, the two or more lock receivers 762 could be spaced around prong adapter 330 at other multiples of 45 degrees of rotation, such as every 90 degrees, or at other non-45-degree multiples.

The locations of the two or more lock receivers 762 (FIG. 6) of the prong adapter 330 define two or more predetermined orientations along the rotational movement of housing 110 relative to prong adapter 330 (FIGS. 8-15). In the present example, locking mechanism 760 is configured to restrict the rotational movement of the housing 110 relative to prong adapter 330 at eight predetermined orientations, separated from each other by one or more multiples of 45 degrees of rotation, (FIGS. 8-15) when lock 761 couples to a respective one of the two or more lock receivers 762 of prong adapter 330 (FIG, 7). In addition, locking mechanism 760 is configured to permit the rotational movement of housing 110 relative to prong adapter 330 when lock 761 is not coupled to any of the two or more lock receivers 762.

In the present embodiment, as shown in FIG. 7, locking mechanism 760 comprises a lock de-actuator 763 coupled to lock 761 and protasding through an exterior of housing 110. Lock de-actuator 763 can be operated by pressing it against housing 110, causing lock 761 to decouple from any of the two or more kick receivers 762 of prong adapter 330 to allow the rotational movement of housing 110 relative to prong adapter 330.

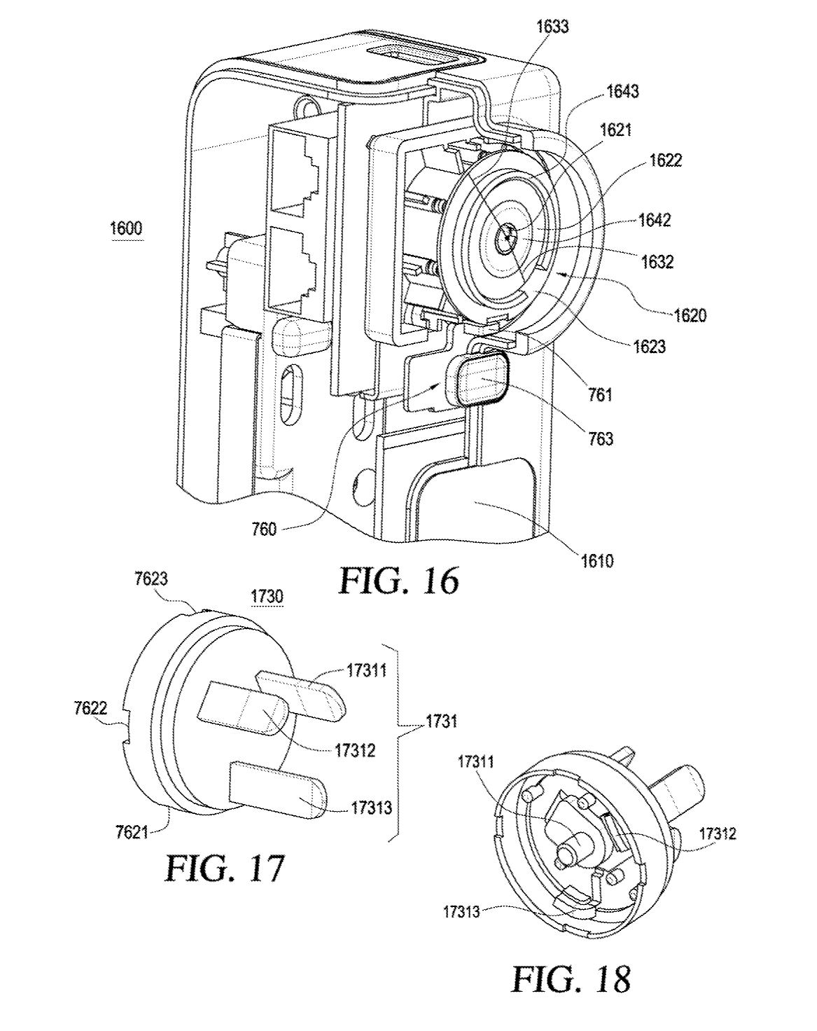

Continuing with the figures, FIG. 16 illustrates a cross sectional, isometric view of a portion of electrical connector 1600, which is a similar embodiment of electrical connector 100 of FIGS. 1-15. FIG. 17 illustrates an isometric front view of a prong adapter 1630. FIG. 18 illustrates an isometric rear view of prong adapter 1630.

As illustrated in FIG. 16, electrical connector 1600 comprises a rotation coupler 1620 comprising prong contact 1621, prong contact 1622, and prong contact 1623 similar to contact 421, contact 422, and contact 423 of rotation coupler 420 (FIG. 4), respectively, for electrical connector 100.

Rotation coupler 1620 is configured with concentric rail contacts such as contacts 1622 and 1623. In the present embodiment, the different prong contacts comprise full rings of different perimeters, with contact 1622 defined by a ring of radius 1632, and contact 1623 defined by a ring of radius 1633. In a different embodiment, the different prong contacts may comprise only part of a full ring. In either case, an outer perimeter of contact 1621 is located within, and electrically isolated from, an inner perimeter of contact 1622. Similarly, an outer perimeter of prong contact 1622 is located within, and electrically isolated from, an inner perimeter of prong contact 1623. In the present embodiment, contacts 1621 and 1622 are electrically isolated from each other by isolation barrier 1642, while contacts 1622 and 1623 are electrically isolated from each other by isolation barrier 1643, where isolation barriers 1642 and 1643 comprise rings of nonconductive material. The rings can be continuous or discontinuous.

As illustrated in FIGS. 17-18, rotation coupler 1620 couples to prong adapter 1730, similar to prong adapter 330 of electrical connector 100 (FIGS. 5-6). Prong adapter 1730 comprises a prong set 1731, having at least two of prong 17311, prong 17312, and prong 17313. In the present example, all three prongs are present in prong set 1731.

As can be seen in FIG. 18, the different prongs of prong set 1731 protrude through the rear of prong adapter 1730. In the same or a different example, the different prongs do not protrude through the rear of prong adapter 1730 at a point directly opposite to the respective prong at the front of prong adapter 1730 (FIG. 17). Instead, they are routed internally through prong adapter 1730 to protrude at a point aligned with the perimeter of their respective prong contact at rotation coupler 120. In the present example, prong 17311 protrudes through the center of the rear of prong adapter 1730, lining up with prong contact 1621 (FIG. 16) at the center of rotation coupler 1620. Similarly, prong 17312 protrudes through the rear of prong adapter 1730 at a point separated from the center of prong adapter 1730 by radius 1632, the same radius that defines prong contact 1622 (FIG. 16) Likewise, prong 17313 protrudes through the rear of prong adapter 1730 at a point separated from the center of prong adapter 1730 by radius 1633, the same radius that defines prong contact 1623 (FIG. 16).

Because of the radial alignments described above, when prong adapter 1730 (FIGS. 17-18) is coupled to rotation coupler 1620 (FIG. 16), prong contact 1621 couples with prong 17311, and prong contact 1622 couples with prong 17312. In addition, while housing 1610 is rotated relative to prong adapter 1730, prong contact 1621 remains coupled to prong 17311, and prong contact 1622 remains coupled to prong 17312.

In the present and other embodiments where prong adapter 1730 comprises each of prong 17311, prong 17312, and prong 17313, prong contact 1623 couples with prong 17313 when prong adapter 1730 is coupled to rotation coupler 1620. In addition, while housing 1610 is rotated relative to prong adapter 1730, prong contact 1623 remains coupled to prong 17313.

Although electric connector 1600 is shown in an exploded view in FIGS. 16-18, with prong adapter 1730 separated from rotation coupler 1620, electric connector 1600 can be configured such that prong adapter 1730 is not removable from rotation coupler 1620, while still retaining the capability of allowing rotational movement.

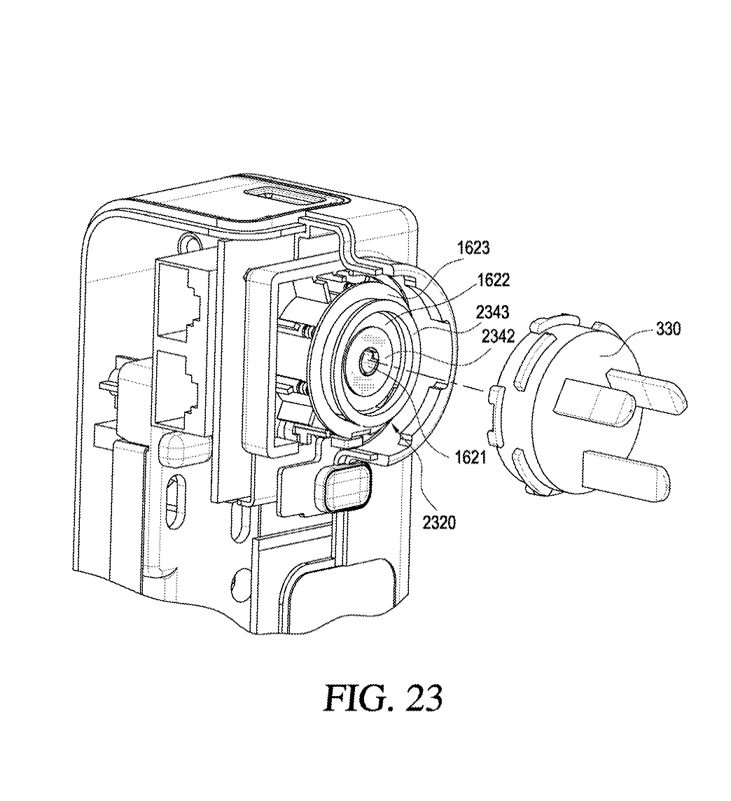

Skipping ahead with the figures, FIG. 23 illustrates a rotation coupler 2320, which is a related embodiment of rotation coupler 1620 from FIG. 16. Rotation coupler 2320 differs from rotation coupler 1620 by further comprising retainer ring 2342 coupled to a top of isolation barrier 1642 (FIG. 16), and retainer ring 2343 coupled to a top of the isolation barrier 1643 (FIG. 16). Retainer rings 2342 and 2343 keep the contacts 1621-1623 in place when prong adapter 330 is removed from rotation coupler 2320. Under such circumstances, retainer ring 2342 couples with and retains the outer perimeter of prong contact 1621 and the inner perimeter of prong contact 1622, while retainer ring 2343 couples with and retains the outer perimeter of prong contact 1622 and the inner perimeter of prong contact 1623.

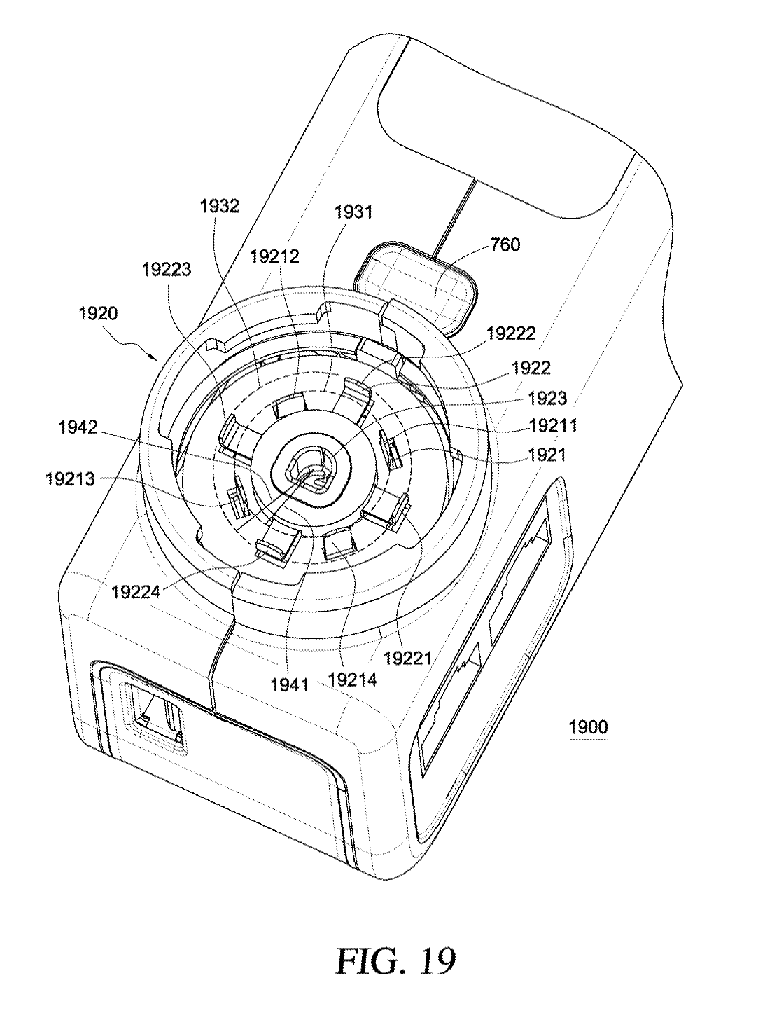

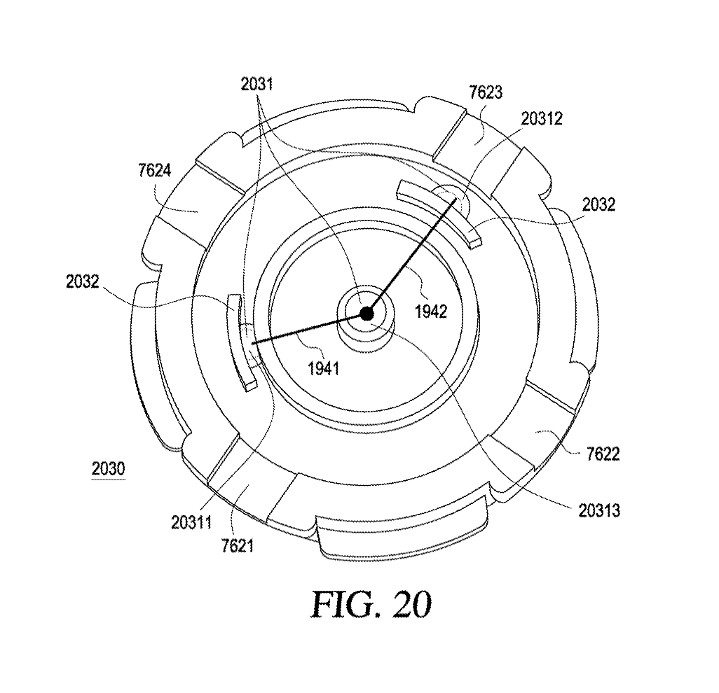

Backtracking through the figures FIG. 19 illustrates an isometric view of a portion of electrical connector 1900, which is a similar embodiment of electrical connector 100 of FIGS. 1-15 and electrical connector 1600 of FIGS. 16-18, without a prong adapter. FIG. 20 illustrates a rear view of prong adapter 2030, which is a similar embodiment of prong adapter 330 of FIGS. 1-15, and prong adapter 1730 of FIGS. 17-18.

As illustrated in FIG. 19, electrical connector 1900 comprises a rotation coupler 1920 similar to rotation coupler 420 (FIG. 4) of electrical connector 100. Rotation coupler 1920 comprises a central contact 1923, contact set 1921 with two or more contact points along perimeter 1931 defined by radius 1941 from central contact 1923, and a contact set 1922 with two or more second contact points along perimeter 1932 defined by radius 1942 from central contact 1923. In the present example, the two or more first contact points of contact set 1921 are evenly separated along perimeter 1931, while the two or more second contact points of contact set 1922 are evenly separated along perimeter 1932. Electrical connector 1900 also comprises locking mechanism 760, as illustrated in FIG. 7.

Central contact 1923 can comprise one of a line contact, a neutral contact, and a ground contact, similar to as described for electrical connector 100 above. In turn, contact set 1921 can comprise a different one of the line contact, the neutral contact, and the ground contact. Finally, contact set 1922 can comprise another one of the line contact, the neutral contact, and the ground contact.

In the present embodiment, the two or more first contact points of contact set 1921 comprise four contact points 19211-19214, and the two or more second contact points of contact set 1922 comprise four contact points 19221-19224. Perimeters 1931 and 1932 are imaginary, because contact sets 1921 and 1922 do not form a solid ring and are instead composed of discrete contact points 19211-19214 and 19221-19224,

Central contact 1923 is located within perimeter 1931 of contact set 1921. In addition, perimeter 1931 of contact set 1921 is located within perimeter 1932 of contact set 1922. Central contact 1923, contact set 1921, and contact set 1922 are electrically isolated from each other in rotation coupler 1920.

As illustrated in FIG. 20, electrical connector 1900 further comprises a prong adapter 2030, similar to prong adapter 330 of electrical connector 100 (FIGS. 5-6). Prong adapter 2030 comprises a prong set 2031, having at least two of prong 20311, prong 20312, and prong 20313. Prong 20311 can comprise one of a line prong, a neutral prong, and a ground prong, similar to as described for electrical connector 100 above. Prong 20312 can comprise a different one of the line prong, the neutral prong, and the ground prong. Finally, prong 20313 can comprise another one of the line prong, the neutral prong, and the ground prong. In the present example, all three prongs are present in prong set 2031

As can be seen in FIG. 20, the different prongs of prong set 2031 protrude through the rear of prong adapter 2030 in a manner similar to that described above for prong adapter 1730 (FIG. 18), where the different prongs are routed internally to protrude at the rear of prong adapter 2030 at locations corresponding to their respective contacts in rotation coupler 1920 (FIG. 19). In the present example, prong adapter 2030 further comprises one or more safety guards 2032 configured to at least partially cover one or more of the line prong, the neutral prong, and the ground prong as assigned to prongs 20311-20312. Safety guards 2032 are configured to allow access for the different contacts of rotation coupler 1920 to couple with their respective prongs of prong set 2031, while making it harder for users to contact prong set 2031 with their hands or other objects. Safety guards 2032 can be portions of a circle and can fit between contact set 1921 and contact set 1922.

In the present example, prong 20311 protrudes through the rear of prong adapter 2030 at a distance of radius 1941 from the center of prong adapter 2030. Because the locations for both prong 20311 and contact, set 1921 (FIG. 19) are defined by the same radius 1941, both elements are complementary to each other. As a result, the two or more contact points of contact set 1921 are capable of coupling to only prong 20311 of prong set 2031 when prong adapter 2030 is Socked to rotation coupler 1920 by locking mechanism 760.

Similarly, prong 20312 protrudes through the rear of prong adapter 2030 at a distance of radius 1942 from the center of prong adapter 2030. Because the locations for both prong 20312 and contact set 1922 (FIG. 19) are defined by the same radius 1942, both elements are complementary to each other. As a result, the two or more second contact points of contact set 1922 are capable of coupling to only prong 20312 when prong adapter 2030 is locked to rotation coupler 1920 by locking mechanism 760.

Finally, prong 20313 protrudes through the center of the rear of prong adapter 2030, and is thus complementary to central contact 1923, located at the center of rotation coupler 1920 (FIG. 19). As a result central contact 1923 is capable of coupling to only prong 20313 of prong set 2031 when prong adapter 2030 is locked to rotation coupler 1920 by locking mechanism 760.

In the present example, and in embodiments where prong adapter 2030 comprises prong 20311 of prong set 2031, because of the radial alignments described above, when prong adapter 2030 (FIG. 20) is locked to rotation coupler 1920 (FIG. 19) by the latching of locking mechanism 760 (FIGS. 7 and 19) to any of lock receivers 7621-7624 (FIG. 20), at least one of contact points 19211-19214 of contact set 1921 couples with prong 20311.

Similarly, in the present example, and in embodiments where prong adapter 2030 comprises prong 20312 of prong set 2031, again because of the radial alignments described above, when prong adapter 2030 (FIG. 20) is locked to rotation coupler 1920 (FIG. 19) by the latching of locking mechanism 760 (FIGS. 7 and 19) to any of lock receivers 7621-7624 (FIG. 20), at least one of contact points 19221-19224 of contact set 1922 couples with prong 20311.

Finally, in the present example, and in embodiments where prong adapter 2030 comprises prong 20313 of prong set 2031, when prong adapter 2030 (FIGS. 20) is coupled to rotation coupler 1920 (FIG. 19), central contact 1923 couples to prong 20313.

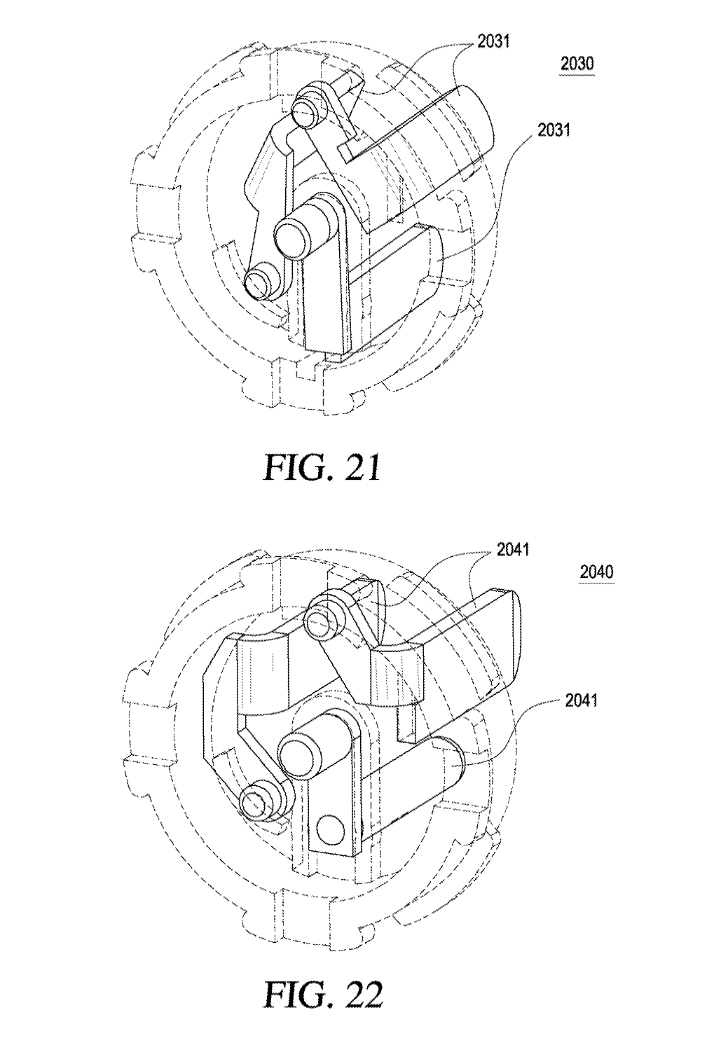

Continuing with the figures, FIG. 21 illustrates a translucent rear view of prong adapter 2030. FIG. 22 illustrates a translucent rear view of prong adapter 2040, which is interchangeable with prong adapter 2030. As illustrated in FIGS. 19-21 for electrical connector 1900, prong adapter 2030 is removable from rotation coupler 1920. In the same or a different example, electrical connector 1900 can further comprise prong adapter 2040 (FIG. 22). Prong adapter 2040 is similar to prong adapter 2030, and is also configured to couple to rotation coupler 1920. As a result, prong adapter 2040 is interchangeable with prong adapter 2030 to couple to rotation coupler 1920.

Prong adapter 2040 comprises prong set 2041 with at least two of a line prong, a neutral prong, and a ground prong. Similar to prong set 2031 of prong adapter 2030, the prongs of prong set 2041 are configured to protrude at the rear of prong adapter 2040 at points with radial alignments similar to those discussed above for prong adapter 2030 and corresponding to their respective contacts at rotation coupler 1920. As a result, the line prong, the neutral prong, and the ground prong of prong set 2041 are configured to couple with their respective line contact, neutral contact, and ground contact of rotation coupler 1920.

As illustrated in FIGS. 21-22, the shape and arrangement of the prongs on both prong sets 2031 and 2041 differ as they protrude from the front side of prong adapters 2030 and 2040, respectively. In the present example, prong adapter 2030 is configured to be compliant with a first AC prong standard for Australia. Similarly, prong adapter 2040 is configured to be compliant with a second AC prong standard for the United States. Nevertheless, the positional relationship of the prongs as they protrude from the rear side of both prong adapters 2030 and 2040 is substantially constant in both cases. This arrangement allows flexibility when traveling abroad, permitting the use of electrical connector 1900 on electrical sources of different countries having different AC prong standards by simply coupling the appropriate prong adapter to rotation coupler 1920.

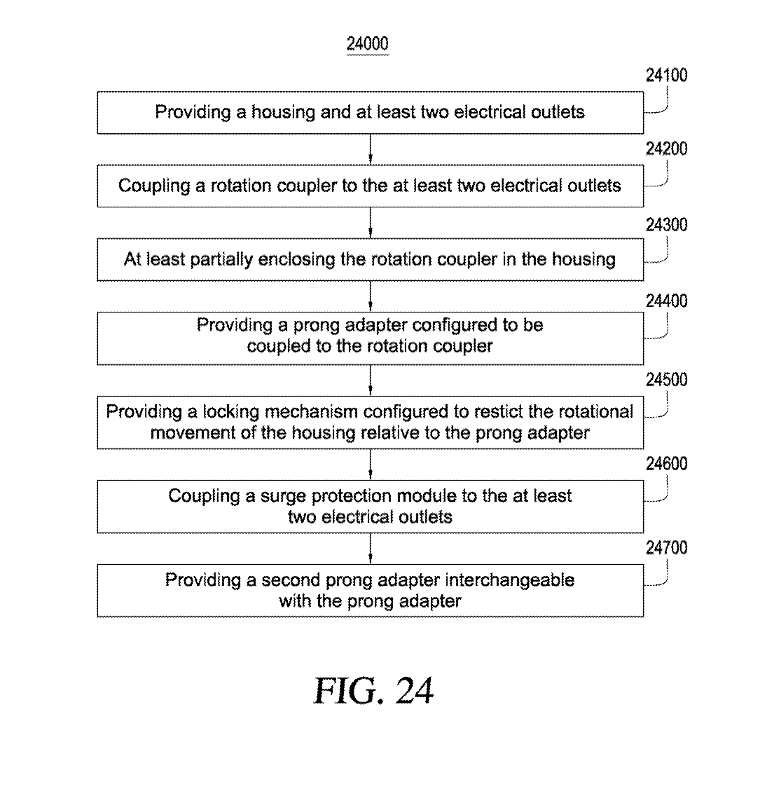

Continuing with the figures, FIG. 24 illustrates a flowchart of a method 24000 for manufacturing an electrical connector. The electrical connector in method 24000 can comprise, for example, electrical connector 100 of FIGS. 1-5, electrical connector 1600 of FIGS. 16-18, and electrical connector 1900 of FIGS. 19-21.

For method 24000, manufacturing the electrical connector can comprise making the electrical connector available to purchasers or users, for example, by the manufacturer of the electrical connector, distributors, marketers, or resellers. The electrical connector can be made available via wholesale distribution methods, and/or through retail networks that cater to midstream parties or end users.

Block 24100 of method 24000 involves providing a housing and at least two electrical outlets. As an example the housing can be housing 110 as shown in FIGS. 1-15 for electrical connector 100, or a similar housing or case from any of the electrical adapters described above. Similarly, the at least two electrical outlets can comprise any of the electrical outlets described above for the different electrical connectors, including AC outlets, USB outlets, Ethernet outlets, and/or telephone jacks. The at least two outlets can be coupled to the housing such that they are accessible externally through the case, while having provisions for connections internally to the housing.

Block 24200 of method 24000 involves coupling a rotation coupler to the at least two electrical outlets. In one example, the rotation coupler can be similar to rotation coupler 420 (FIG. 4) from electrical connector 100, or to any rotation coupler or coupling section from any of the electrical connectors described above, and can comprise a line contact, a neutral contact, and a ground contact. The rotation coupler of block 24200 is coupled to the at least two electrical outlets described in block 24100 internally to the housing.

Block 24300 of method 24000 involves at least partially enclosing the rotation coupler in the housing. As an example, the rotation coupler can be partially enclosed as illustrated for rotation couplers 1620 and 1920 in FIGS. 16 and 19, respectively, wherein the rotation coupler is secured by the housing while leaving an opening for the line, neutral, and ground contacts accessible to the exterior of the housing.

Block 24400 of method 24000 involves providing a prong adapter configured to be coupled to the rotation coupler. In one example, the prong adapter can be similar to prong adapter 330 (FIG. 3) of electrical connector 100 in FIGS. 1-15, or to any other prong adapter described above for other electrical connectors. The prong adapter comprises a prong set comprising at least two of a line prong, a neutral prong, and a ground prong, similar to as described for other prong adapters above. The prong adapter of block 24400 couples to the rotation coupler through the opening at the exterior of the housing described in block 24300. When the prong adapter and the rotation coupler of method 24000 are coupled together, the line contact couples to the line prong, and the neutral contact couples to the neutral prong. In addition, in embodiments comprising a ground prong, the ground contact couples to the ground prong. The rotation coupler of method 24000 is also configured to allow a rotational movement of the housing relative to the prong adapter when the prong adapter is coupled to the rotation coupler, similar to the rotational movement described above for electrical connector 100 in FIGS. 8-15.

Method 24000 can comprise a block 24500, comprising providing a locking mechanism configured to restrict the rotational movement of the housing relative to the prong adapter. The locking mechanism can be similar to locking mechanism 760, as illustrated in FIG. 7 for the electrical connectors described above.

Method 24000 can also comprise a block 24600, comprising coupling a surge protection module to the at least two electrical outlets. In one example, the surge protection module can be surge protection module 750 as described above for electrical connector 100 in FIG. 7. The surge protector can be contained by the housing, being coupled internally to the housing between the two or more electrical connectors and the rotation coupler

Method 24000 can further comprise a block 24700, comprising providing a second prong adapter interchangeable with the prong adapter of Block 24400. As an example, the second prong adapter can be as described for electrical connector 1900, where second prong adapter 2040 (FIG. 22) is interchangeable with prong adapter 2030 (FIGS. 20-21) for coupling with rotation coupler 1920. The second prong adapter can be configured to comply with an AC prong standard different than the AC prong standard to which the prong adapter of Block 24400 is compliant with.

In one embodiment blocks 24100, 24200, 24300, 24400, 24500, 24600, and 24700 of method 24000 can be subparts of a single step. In the same or a different embodiment, the sequence of blocks 24100, 24200, 24300, 24400, 24500, 24600, and 24700 of method 24000 can be otherwise changed. Also, blocks 24500, 24600, and 24700 can be optional depending on the specific example of electrical connector being manufactured.

Although the invention has been described with reference to specific embodiments, it will be understood by those skilled in the art that various changes may be made without departing from the spirit or scope of the invention. For example, to one of ordinary skill in the art, it will be readily apparent that the electrical connector can comprise an electrical plug or prong adapter that conforms to European or other country standards, instead of a plug that conforms to United States or Australian standards. In the same or a different example, the electrical connector (and not only the prong adapter) can comprise a two-prong plug, instead of a three-prong plug. In at least some embodiments, the housing can be referred to as a case, the rotation coupler can be referred to as a coupling section, the lock can be referred to as a tab; the lock receivers can be referred to as lock notches, the lock de-actuator can be referred to as a lock switch, the prong adapter can be referred to as a revolver platform, and/or the predetermined orientations can be referred to as standard orientations. Additional examples have been given in the foregoing description. Accordingly, the disclosure of embodiments of the invention is intended to be illustrative of the scope of the invention and is not intended to be limiting. It is intended that the scope of the invention shall be limited only to the extent required by the appended claims.

For example, to one of ordinary skill in the art, it will be readily apparent that the electrical connector and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be constated as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. An apparatus for providing electrical power, the apparatus comprising:
a housing;
at least two electrical outlets accessible through the housing;
a rotation coupler at least partially enclosed by the housing and coupled to the at least two electrical outlets; and
a prong adapter configured to be coupled to the rotation coupler; wherein:
the rotation coupler comprises:
a line contact;
a neutral contact; and
a ground contact;
the prong adapter comprises a prong set with at least two of:
a line prong configured to couple with the line contact;
a neutral prong configured to couple with the neutral contact; and
a ground prong configured to couple with the ground contact; and
the rotation coupler is configured to allow a rotational movement of the housing relative to the prong adapter.

2. The apparatus of claim 1, wherein:
the rotational movement of the housing comprises 360 degrees of rotation relative to the prong adapter.

3. The apparatus of claim 1, further comprising:
a surge protection module contained within the housing and coupled to the at least two electrical outlets.

4. The apparatus of claim 1, wherein:
the at least two electrical outlets comprise at least one of:
an AC outlet;
a USB socket;
an Ethernet socket; and
a telephone jack.

5. The apparatus of claim 1, wherein:
the at least two electrical outlets comprise:
two AC outlets; and
a USB socket.

6. The apparatus of claim 1, wherein:
the prong adapter further comprises one or more safety guards configured to at least partially cover one or more of the line prong, the neutral prong, and the ground prong.

7. The apparatus of claim 1, wherein the prong adapter is not removable from the rotation coupler.

8. The apparatus of claim 1, wherein the prong adapter is removable from the rotation coupler.

9. The apparatus of claim 8, further comprising:
a second prong adapter configured to be coupled to the rotation coupler;
wherein the second prong adapter is interchangeable with the prong adapter.

10. The apparatus of claim 9, wherein:
the second prong adapter comprises a second prong set with at least two of:
a second line prong configured to couple with the line contact of the rotation coupler;
a second neutral prong configured to couple with the neutral contact of the rotation coupler; and
a second ground prong configured to couple with the ground contact of the rotation coupler.

11. The apparatus of claim 9, wherein:
the prong adapter is compliant with a first prong standard; and
the second prong adapter is compliant with a second prong standard.

12. The apparatus of claim 1, wherein:
a first dimension of the housing is approximately 130 mm;
a second dimension of the housing is approximately 50 mm;
a third dimension of the housing is approximately 41 mm.
a neck protrudes from the housing approximately 9 mm; and
the neck comprises a diameter of approximately 38.5 mm.

13. The apparatus of claim 1, wherein:
the rotation coupler comprises:
a first contact comprising one of the line contact, the neutral contact, and the ground contact;
a second contact comprising a different one of the line contact, the neutral contact, and the ground contact; and
a third contact comprising another one of the line contact, the neutral contact, and the ground contact;
an outer perimeter of the first contact is located within and isolated from an inner perimeter of the second contact; and
an outer perimeter of the second contact is located within and isolated from an inner perimeter of the third contact.

14. The apparatus of claim 13, further comprising:
a first isolation barrier between the first contact and the second contact;
a second isolation barrier between the second contact and the third contact;
first retainer ring coupled to a top of the first isolation barrier; and
a second retainer ring coupled to a top of the second isolation barrier;
wherein, when the prong adapter is not coupled to the rotation coupler:
the first retainer ring couples with the outer perimeter of the first contact and the inner perimeter of the second contact; and
the second retainer ring couples with the outer perimeter of the second contact and the inner perimeter of the first contact.

15. The apparatus of claim 13 wherein:
the prong set comprises at least two of:
a first prong comprising one of the line prong, the neutral prong, and the ground prong;
a second prong comprising a different one of the line prong, the neutral prong, and the ground prong; and
a third prong comprising another one of the line prong, the neutral prong, and the ground prong;
the first contact couples with only the first prong when the prong adapter is coupled to the rotation coupler;
the first contact remains coupled to the first prong when the housing is rotated relative to the prong adapter;
the second contact couples with only the second prong when the prong adapter is coupled to the rotation coupler, and
the second contact remains coupled to the second prong when the housing is rotated relative to the prong adapter.

16. The apparatus of claim 15, wherein:
the third contact couples with only the third prong when the prong adapter is coupled to the rotation coupler; and
the third contact remains coupled to the third prong when the housing is rotated relative to the prong adapter.

17. The apparatus of claim 1, wherein:
the rotation coupler further comprises a first portion of a locking mechanism;
the first portion of the locking mechanism comprises a lock;
the prong adapter further comprises a second portion of the locking mechanism;
the second portion of the locking mechanism comprises a first lock receiver of two or more lock receivers configured to couple with the lock;
the rotational movement of the housing relative to the prong adapter comprises a first predetermined orientation of two or more predetermined orientations; and
the locking mechanism is configured to restrict the rotational movement of the housing relative to the prong adapter at the first predetermined orientation when the lock is coupled to the first lock receiver.

18. The apparatus of claim 17, wherein:
the locking mechanism is configured to cease restricting the rotational movement of the housing relative to the prong adapter when the lock is decoupled from the first lock receiver.

19. The apparatus of claim 17, wherein:
the locking mechanism further comprises a lock de-actuator coupled to the lock and protruding through an exterior of the housing; and
the lock de-actuator is configured to decouple the lock from the first lock receiver when the lock de-actuator is operated.

20. The apparatus of claim 17, wherein:
the two or more predetermined orientations are separated from each other by one or more multiples of 45 degrees of rotation.

21. The apparatus of claim 17, wherein:
the prong set comprises at least two of:
a first prong comprising one of the line prong, the neutral prong, and the ground prong;
a second prong comprising a different one of the line prong, the neutral prong, and the ground prong; and
a third prong comprising another one of the line prong, the neutral prong, and the ground prong;
the rotation coupler comprises:
a central contact comprising one of the line contact, the neutral contact, and the ground contact;
a first contact set comprising a different one of the line contact, the neutral contact, and the ground contact; and
a second contact set comprising another one of the line contact, the neutral contact, and the ground contact;
the first contact set comprises two or more first contact points along a first perimeter defined by a first radius from the central contact;
a second contact set comprises two or more second contact points along a second perimeter defined by a second radius from the central contact;
the central contact is located within the first perimeter of the first contact set and isolated from the two or more first contact points of the first contact set; and
the first perimeter of the first contact set is located within the second perimeter of the second contact set and isolated from the two or more second contact points of the second contact set.

22. The apparatus of claim 21, wherein:
the two or more first contact points of the first contact set are configured to couple with only the first prong when the prong adapter is locked to the rotation coupler by the locking mechanism; and
at least one of the two or more first contact points of the first contact set couples with the first prong when the prong adapter is locked to the rotation coupler by the locking mechanism.

23. The apparatus of claim 21, wherein:
the two or more second contact points of the second contact set are configured to couple with only the second prong when the prong adapter is locked to the rotation coupler by the locking mechanism; and
at least one of the two or more second contact points of the second contact set couples with the second prong when the prong adapter is locked to the rotation coupler by the locking mechanism.

24. The apparatus of claim 21, wherein:
the central contact is configured to couple with only the third prong when the prong adapter is locked to the rotation coupler by the locking mechanism.

25. The apparatus of claim 21, wherein:
the two or more first contact points are evenly separated along the first perimeter; and
the two or more second contact points are evenly separated along the second perimeter.

26. A method of manufacture for an electrical connector, the method comprising:
providing a housing and at least two electrical outlets;
coupling a rotation coupler to the at least two electrical outlets;
at least partially enclosing the rotation coupler in the housing; and
providing a prong adapter configured to be coupled to the rotation coupler; wherein:
the prong adapter comprises a prong set with at least two of:
a line prong;
a neutral prong; and
a ground prong;
the rotation coupler comprises:
a line contact capable of being coupled to the line prong;
a neutral contact capable of being coupled to the neutral prong; and
a ground contact capable of being coupled to the ground prong; and
the rotation coupler is configured to allow a rotational movement of the housing relative to the prong adapter.

27. The method of claim 26, further comprising:
providing a locking mechanism configured to restrict the rotational movement of the housing relative to the prong adapter.

28. The method of claim 26, further comprising:
coupling a surge protection module to the at least two electrical outlets.

29. The method of claim 26, further comprising:
providing a second prong adapter interchangeable with the prong adapter.

30. An electrical power adapter comprising:
a case;
at least two electrical outlets accessible through the case;
a coupling section accessible through the case and coupled to the at least two electrical outlets;
a revolver platform configured to be coupled to the coupling section;
a surge protection module configured to couple to the at least two electrical outlets; and
a locking mechanism comprising:
a lock tab coupled to the coupling section;
a first lock notch of two or more lock notches complementary to the lock tab and coupled to the revolver platform; and
a lock switch coupled to the lock tab and protruding through an exterior of the case;
wherein:
the coupling section comprises:
a line contact located a first distance away from a center of the coupling section;
a neutral contact located a second distance away from the center of the coupling section; and
a ground contact located a third distance away from the center of the coupling section;
the revolver platform comprises a prong set comprising at least two of:
a line prong with a line coupler located a first distance away from a center of the revolver platform;
a neutral prong with a neutral coupler located a second distance away from the center of the revolver platform; and
a ground prong with a ground coupler located a third distance away from the center of the revolver platform;
the first distance from the center of the coupling section is substantially equal to the first distance from the center of the revolver platform;
the second distance from the center of the coupling section is substantially equal to the second distance from the center of the revolver platform;
the third distance from the center of the coupling section is substantially equal to the third distance from the center of the revolver platform;
the line coupler of the line prong is capable of being coupled to the line contact of the coupling section;
the neutral coupler of the neutral prong is capable of being coupled to the neutral contact of the coupling section;
the ground coupler of the ground prong is capable of being coupled to the ground contact of the coupling section;
the coupling section is configured to allow a rotational movement of the case relative to the revolver platform;
the rotational movement of the case relative to the revolver platform comprises a first standard orientation of two or more standard orientations;
the locking mechanism is configured to restrict the rotational movement of the case relative to the revolver platform at the first standard orientation when the lock tab is coupled to the first lock notch;
the locking mechanism is configured to cease restricting the rotational movement of the case relative to the revolver platform when the lock tab is decoupled from any of the two or more lock notches;
the lock switch is configured to decouple the lock tab from any of the two or more lock notches when the lock switch is depressed;
the two or more lock notches are spaced around the revolver platform in increments comprising one or more multiples of 45 degrees of rotation; and
the at least two electrical outlets comprise at least one of;
an AC outlet;
a USB socket;
an Ethernet socket; and
a telephone jack.

31. The electrical power adapter of claim 30, wherein:
the coupling section comprises:
a first contact ring comprising one of the line contact, the neutral contact, and the ground contact;
a second contact ring comprising a different one of the line contact, the neutral contact, and the ground contact; and
a third contact ring comprising another one of the line contact, the neutral contact, and the ground contact;
the prong set of the revolver platform comprises at least two of:
a first coupler comprising one of the line coupler, the neutral coupler, or the ground coupler;
a second coupler comprising a different one of the line coupler, the neutral coupler, or the ground coupler; and
a third coupler comprising another one of the line coupler, the neutral coupler, or the ground coupler;
an inner perimeter of the second contact ring is greater than an outer perimeter of the first contact ring;
an inner perimeter of the third contact ring is greater than the outer perimeter of the first contact ring;
the first contact ring, the second contact ring, and the third contact ring are substantially planar with, and electrically isolated from, each other;
the first contact ring is configured to couple to the first coupler;
the second contact ring is configured to couple to the second coupler;
the third contact ring is configured to couple to the third coupler; and
when the case is rotated relative to the revolver platform:
the first contact ring of the coupling section remains coupled to the first coupler;
the second contact ring of the coupling section remains coupled to the second coupler, and
the third contact ring of the coupling section remains coupled to the third coupler.

32. The electrical power adapter of claim 30, wherein:
the prong set of the revolver platform comprises at least two of:
a first coupler comprising one of the line coupler, the neutral coupler, or the ground coupler;
a second coupler comprising a different one of the line coupler, the neutral coupler, or the ground coupler; and
a third coupler comprising another one of the line coupler, the neutral coupler, or the ground coupler;
the revolver platform comprises one or more safety guards configured to at least partially cover one or more of the first coupler, the second coupler, and the third coupler;
the coupling section comprises:
a central contact comprising one of the line contact, the neutral contact, and the ground contact;
a first contact set with two or more first contact points comprising a different one of the line contact, the neutral contact, and the ground contact; and
a second contact set with two or more second contact points comprising another one of the line contact, the neutral contact, and the ground contact; and
when the revolver platform is locked to the coupling section by the locking mechanism:
at least one of the two or more first contact points of the first contact set couples with the first coupler of the prong set;
at least one of the two or more second contact points of the second contact set couples with the second coupler of the prong set, and
the central contact couples with the third coupler of the prong set.

33. The electrical power adapter of claim 30, further comprising:
a second revolver platform configured to be coupled to the coupling section;
wherein:
the second revolver platform is interchangeable with the revolver platform;
the revolver platform is compliant with a first prong standard; and
the second revolver platform is compliant with a second prong standard.
